(19) United States
(12) Patent Application Publication
(10) Pub. No.: US 2024/0238956 A1
(43) Pub. Date: Jul. 18, 2024

(54) Nail Gun or Fastener Gun Powered by Thermite Primers

(71) Applicants: University of Central Florida Research Foundation, Orlando, FL (US); Spectre Primer Technologies, Inc., West Palm Beach, FL (US)

(72) Inventors: Timothy Mohler, Melbourne, FL (US); Daniel Yates, Melbourne, FL (US); Kevin R. Coffey, Titusville, FL (US)

(21) Appl. No.: 18/414,265

(22) Filed: Jan. 16, 2024

Related U.S. Application Data
(60) Provisional application No. 63/439,273, filed on Jan. 16, 2023.

(51) Int. Cl. B25C 1/16; B25C 1/14

(52) U.S. Cl. CPC B25C 1/163; B25C 1/143

(57) ABSTRACT

A fastener gun or nail gun utilizes a propellant cartridge having a centerfire primer made from thermite. The thermite is made from alternating layers of metal oxide and reducing metal, and includes one or more layers of carbide-containing ceramic. The primer ignites a propellant which may be a conventional single base or double base smokeless powder, or which may be thermite having a structure similar to the thermite of the primer. The primer may be initiated mechanically or electrically. The fastener gun is capable of applying a level of force similar to the force applied by conventional propellant cartridges, while avoiding inhalation of lead particles by the operator of the fastener gun.

### CROSS REFERENCE TO RELATED APPLICATION

This application claims the benefit of U.S. provisional patent application Ser. No. 63/439,273, which was filed on Jan. 16, 2023, and entitled “Nail Gun or Fastener Gun Powered By Thermite Primers.”

### TECHNICAL FIELD

The present invention relates to fastener guns such as nail guns. More specifically, a fastener gun in which the fastener is driven by a thermite primer, or by a propellant which is ignited by a thermite primer is provided.

### BACKGROUND INFORMATION

Presently available fastener guns such as nail guns include battery-powered, mechanically driven fastener guns, combustible gas powered fastener guns, and fastener guns powered by a primer-ignited smokeless powder.

Battery-powered, mechanically driven nail guns typically utilize a battery-powered electric motor to compress a spring, which is then released to drive a nail into a desired location. Combustible gas powered fastener guns utilize a spark plug to ignite a mixture of gas and air to drive a nail into a desired location. Although compressed gas powered nail guns are typically the more powerful of these two types, neither is sufficiently powerful for all applications.

Nail guns using a primer-ignited smokeless powder provide the greatest energy level for driving nails. However, the propellant cartridges for presently available nail guns utilize a conventional primers which are similar to those used within firearms, and which contain containing lead azide or lead styphnate. Use of these nail guns indoors creates a risk of inhaling lead particles, and is therefore disfavored. Those needing more powerful nail guns are therefore often forced to choose between a less powerful cordless nail gun or a less convenient nail gun. Additionally, presently available cartridges for nail guns utilizes a rimfire priming system, which is generally thought to be less reliable than a centerfire priming system due to the occasional failure to uniformly apply priming compound uniformly around the entire rim area of the casing. A centerfire priming system would result in greater ignition reliability.

Various examples of prior art nail guns or fastener guns are described below. The entire disclosure of each and every references discussed herein is expressly incorporated herein by reference.

An example of a nail gun is disclosed by AU 2009282251 B2, which was invented by W. J. Thompson and published on Feb. 18, 2010. This patent discloses an explosive discharge activated tool having an interchangeable nose piece for accommodating different size fasteners. Inserting a spacer-fastener into the barrel resets the piston to the firing position in a single step, avoiding a two step process of first retracting the piston and then loading the fastener into the barrel.

AU 2019200438 B2, which was issued to F. Masas et al. and published on Feb. 7, 2019, discloses a nail gun using a fastener having a head with an explosive load attached thereto in a plastic cap which includes a buffer. A spring-actuated firing pin ignites the explosive load. The force of the explosive load is also utilized to reset the tool.

U.S. Pat. No. 4,204,473, which was issued to D. Dardick on May 27, 1980, discloses an ignitable charge for open chamber, gas-powered tools. The nitrocellulose charge is contained within a triangular plastic housing with open ends. The charge is ignited by an electric spark.

U.S. Pat. No. 8,960,517, which was issued to C. Y. Lee on Feb. 24, 2015, discloses a powder-actuated fastener-driving device. The device includes a movable sleeve of sound-absorbing material.

U.S. Pat. No. 5,842,623, which was issued to J. D. Dippold on Dec. 1, 1998, discloses a gas primed powder actuated tool. Power is supplied by brass-cased ammunition shells having single base or double base gunpowder therein. Multiple shells are held on a plastic cartridge strip, with each shell retained in a hole within the cartridge strip. Combustible gas is supplied as a compressed liquid such as methyl acetylene propadien. The gunpowder is ignited by an electrical spark applied to a combustible gas The combustible gas then ignites the gunpowder. A piston propelled by the burning gunpowder drives a fastener into a workpiece. A spring returns the piston to its original position.

U.S. Pat. No. 5,215,419, which was issued to W. A. Steinhiber on Jun. 1, 1993, discloses an explosively driven fastener assembly. The nail includes a head having an explosive charge. The exposed end of the explosive charge includes a Zener diode which functions as a primer. A tool utilizing the fastener applies a threshold voltage to the Zener diode causing it to self-destruct, igniting the explosive charge. The explosive charge is one which has been proposed for use in caseless ammunition.

EP 0 529 230 B1, which was issued to R. K. Bjerke et al. on, Jan. 7, 1998, discloses a lead free primed rimfire cartridge. The primer is made from 20%-30% dinol (diazodinitrophenol), 4%-20% tetracene, 0%-12% propellant, 20%-35% ground glass, 20%-40% strontium nitrate, and 0.2%-2.2% water-soluble glue. Single base or double base smokeless powder is used as the propellant.

CN 1042308 C, which was issued to Innovative Quality Products Corp. on Mar. 3, 1999, discloses a tool for driving a fastener into a target work surface. The fastener includes a receptacle end upon which a nitrocellulose charge is mounted. A reciprocable firing pin is used to detonate the charge. The patent claims that the nitrocellulose can be ignited without a primer-detonator.

CN 217572769 U, which was issued to Hebei Jane Engineering Technology Co. Ltd. on Oct. 14, 2022, discloses a nail gun which is intended to be an alternative to a nail gun which is powered by gunpowder. The nail gun includes an automatic power-actuated setting device

U.S. Pat. No. 10,611,009, which was issued to W. S. Huang et al. on Apr. 7, 2020, discloses a nail gun. Compressed air is used to drive a clamp arm towards the punch portion of the tool. When the clamp arm reaches the wooden board and the punch portion, compressed air is permitted to drive a nail into the board.

U.S. Pat. No. 8,485,410, which was issued to B. Harshman on Jul. 16, 2013, discloses a nail gun magazine for stacked fasteners. The magazine includes a chute and a follower for pushing the fasteners. A slide pushes the lead fastener from a separation station to an expulsion station.

U.S. Pat. No. 6,913,180, which was issued to M. G. Schuster on Jul. 5, 2005, discloses a nail gun. The nail gun includes a plurality of supply magazines, each of which is movable into a position for use, permitting different types of fasteners to be selected by switching magazines. The drive mechanism is pneumatically powered.

U.S. Pat. No. 6,837,412, which was issued to F. W. Lamb on Jun. 4, 2005, discloses a cap feeding apparatus for a fastener gun. The tool includes a feeding magazine for cap washers which works in connection with a fastener-driving gun. The magazine feeds successive cap washers under the nose of the fastener gun so that the nails or staples can penetrate the cap washer to hold down the roofing paper or building wrap tar paper under the cap washer.

U.S. Pat. No. 9,333,633, which was issued to S. S. Bayham on May 10, 2016, discloses a dual muzzle nail gun for driving two nails simultaneously.

CN 107413550 A, which was published on Dec. 1, 2017, discloses an automatic spray apparatus for use in connection with a nail gun. As nails are driven, the spray apparatus coats the nail with an oxidation-resistant film.

CN 111673853 A, which was filed by Guangdong Meite Mechanical Co. Ltd. and published on Sep. 18, 2020, discloses a nail gun or staple gun which is designed for use on automated production lines.

The prior art recognizes the need for nail guns which avoid the use of conventional primers while also providing sufficient power to drive nails or other fasteners into materials which require higher power levels to drive fasteners therein. Accordingly, there is a need for a fastener gun or nail gun which is capable of driving nails with a level of power approximating the level of power of a presently available propellant cartridge nail gun, but without creating a hazard of inhaling lead particles. There is an additional need for a cartridge for a fastener gun utilizing a centerfire priming system. There is a further need for the fastener gun to be cordless so that it can easily be used in a variety of locations.

### SUMMARY

The above needs are met by a fastener gun propellant cartridge. The cartridge comprises a casing having a front end and a back end. The back end defines a primer pocket. A propellant is disposed within the casing. A primer is secured within the primer pocket. The primer comprises a substrate having a deposition surface and a rear surface. The primer further comprises alternating layers of metal oxide and reducing metal deposited upon the substrate. At least one carbide-containing ceramic layer is disposed within the alternating layers of metal oxide and reducing metal. When the alternating layers of metal oxide and reducing metal react with each other, the carbide-containing ceramic layer is ignited by the reaction between the reducing metal and metal oxide, resulting in ignition of the propellant.

The above needs are further met by a fastener gun powered by a centerfire fastener gun propellant cartridge. The fastener gun comprises a housing, a fastener dispensing chamber within the housing, and a firing mechanism within the housing. The firing mechanism is aligned with the fastener dispensing chamber, and is thereby structured to initiate a centerfire primer of a fastener gun propellant cartridge. The fastener gun further comprises a cartridge ignition location for receiving a fastener gun propellant cartridge. The cartridge ignition location is structured to position a cartridge within the cartridge channel between the firing mechanism and the fastener dispensing channel.

These and other aspects of the invention will become more apparent through the following description and drawings.

### BRIEF DESCRIPTION OF THE DRAWINGS

FIG. 1 is a sectional, side elevational view of a layered thermite structure, a carbide-containing ceramic layer, and passivation coating of a primer.

FIG. 2 is a sectional, side elevational view of an alternative layered thermite structure, a pair of carbide-containing ceramic layers, and passivation coating of a primer.

FIG. 3 is a sectional, side elevational view of another alternative layered thermite structure, a carbide-containing ceramic layer, and passivation coating of a primer.

FIG. 4 is a cross sectional side elevational view of a fastener cartridge utilizing a primer of FIGS. 1-3 and a conventional propellant.

FIG. 5 is a cross sectional side elevational view of a fastener cartridge utilizing a primer of FIGS. 1-3 and a thermite propellant.

FIG. 6 is a top plan view of a retainer strip for holding a plurality of fastener cartridges for sequential use in a fastener gun.

FIG. 7 is a side elevational view of the retainer strip of FIG. 1, showing fastener cartridges retained therein.

FIG. 8 is a schematic cross sectional view of a fastener gun utilizing fastener cartridges of FIGS. 4-5, utilizing mechanical ignition.

FIG. 9 is a schematic cross sectional view of a fastener gun utilizing fastener cartridges of FIGS. 4-5, utilizing electrical ignition.

Like reference characters denote like elements throughout the drawings.

### DETAILED DESCRIPTION

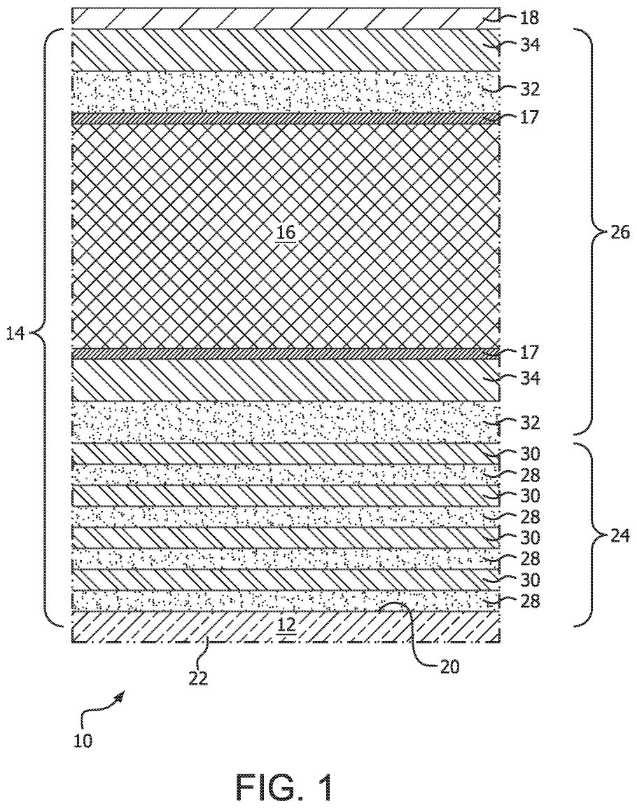

Referring to the drawings, a primer structure and a fastener gun utilizing the primers to propel fasteners is illustrated. Referring to FIGS. 1-3, a primer composition 10 is shown. Examples of the primer composition and a method of making the primer are explained in U.S. Pat. No. 11,650,037, which was issued to Daniel Yates on May 16, 2023, as well as U.S. Pat. No. 10,882,799, which was issued to Kevin R. Coffey at al. on Jan. 5, 2021, and the entire disclosure of both references is expressly incorporated herein by reference. Primers may also be made as disclosed in U.S. provisional patent application No. 63/462,995, which was filed on Apr. 29, 2023 by Daniel Yates. The primer composition 10 is deposited upon a substrate 12. The primer composition includes a layered thermite coating 14, one or more carbide-containing ceramic layer(s) 16 within the layered thermite coating 14, and a passivation coating 18.

The nature of the substrate 12 may depend on the intended means of initiation. A primer having a layered thermite composite 10 may be initiated either electrically or mechanically. The substrate 12 in the illustrated example, which is intended for mechanical initiation, is a malleable, flexible substrate, made from a material such as brass, copper, soft steel, and/or stainless steel, having a deposition surface 20 upon which the layered thermite coating 14 is deposited, and a rear surface 22. Some examples of the substrate 12 are a sufficiently thin and malleable so that a firing pin strike to the rear surface 22 will ignite the layered thermite coating 14 and carbide-containing ceramic layer(s) 16 as described below, but is sufficiently thick for ease of manufacturing the primer composition 10. A preferred substrate thickness is about 0.005 inch to about 0.1 inch, and is more preferably about 0.01 to about 0.025 inch. Other examples of the substrate 12 may be made partially or completely from material which resists the flow of electricity, for example, various plastics, polymers, glass, or rubber materials. A substrate which includes some portions made from electrically resistive material is anticipated to be useful for a fastener gun utilizing electrical ignition, as described in greater detail below. For example, such a substrate could potentially include conductive portions serving as electrical contacts with resistive portions therebetween.

The layered thermite coating 14 includes alternating layers of metal oxide and reducing metal (with only a small number of layers illustrated for clarity). Examples of metal oxides include La₂O₃, AgO, ThO₂, SrO, ZrO₂, UO₂, BaO, CeO₂, B₂O₃, SiO₂, V₂O₅, Ta₂O₅, NiO, Ni₂O₃, Cr₂O₃, MoO₃, P₂O₅, SnO₂, WO₂, WO₃, Fe₃O₄, CoO, Co₃O₄, Sb₂O₃, PbO, Fe₂O₃, Bi₂O₃, MnO₂, Cu₂O, and CuO. Example reducing metals include Al, Zr, Th, Ca, Mg, U, B, Ce, Be, Ti, Ta, Hf, and La.

The thickness of each metal oxide layer and reducing metal layer are determined to ensure that the proportions of metal oxide and reducing metal are such so that both will be substantially consumed by the exothermic reaction. As one example, in the case of a metal oxide layer made from CuO and reducing metal layer made from Mg, the chemical reaction is CuO+Mg->Cu+MgO+heat. The reaction therefore requires one mole of CuO, weighing 79.5454 grams/mole, for every one mole of Mg, weighing 24.305 grams/mole. CuO has a density of 6.315 g/cm³, and magnesium has a density of 1.74 g/cm³. Therefore, the volume of CuO required for every mole is 12.596 cm³. Similarly, the volume of Mg required for every mole is 13.968 cm³. Therefore, within the illustrated example, each layer of metal oxide is about the same thickness or slightly thinner than the corresponding layer of reducing metal. If other metal oxides and reducing metals are selected, then the relative thickness of the metal oxide and reducing metal can be similarly determined.

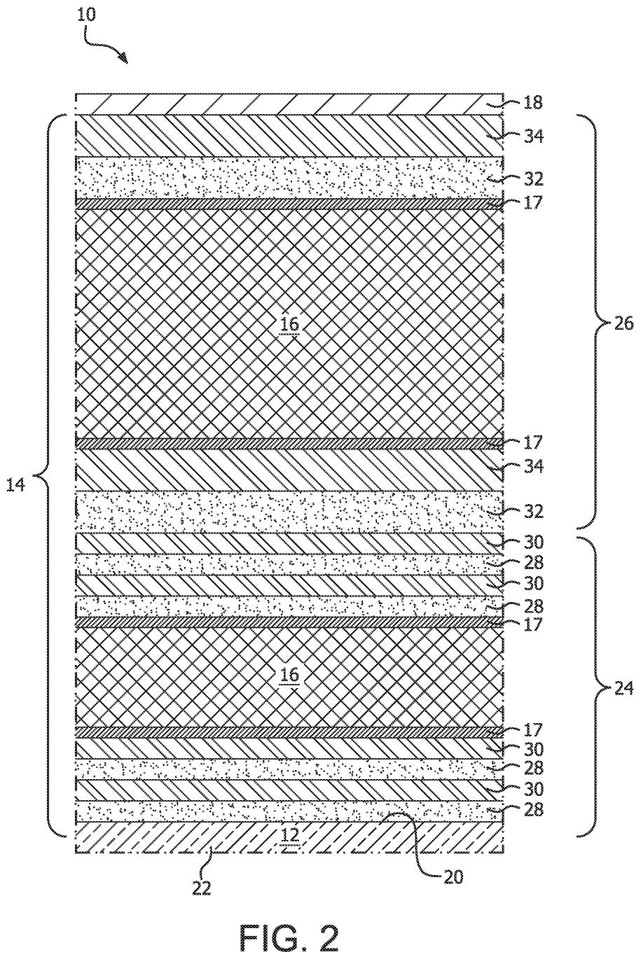

The illustrated example in FIGS. 1 and 2 of a layered thermite coating 14 is divided into an initial ignition portion 24 that is deposited directly onto the substrate 12, and a secondary ignition portion 26 that is deposited onto the initial ignition portion 24. The illustrated example of the initial ignition portion 24 includes layers of metal oxide 28 and reducing metal 30 that are thinner than the layers of metal oxide 32 and reducing metal 34 within the secondary ignition portion 26. In the illustrated example, each metal oxide 28 and reducing metal 30 pair of layers are preferably between about 20 nm and about 100 nm thick, with the illustrated example having pairs of layers that are about 84 nm thick. In the illustrated example, each pair of metal oxide 32 and reducing metal 34 layers are thicker than about 100 nm thick. Thinner layers result in more rapid burning and easier ignition, while thicker layers provide a slower burn rate. The thinner layers 28, 30 within the initial ignition portion 24 are more sensitive to physical impacts, thereby facilitating ignition in response to a firing pin strike to the rear surface 22 of the substrate 12, and ignite the secondary ignition portion 26. The thicker layers 32, 34 within the secondary ignition portion 26 burn more slowly, enhancing the reliability of the ignition of the smokeless powder, thermite propellant, or other desired ignitable substance. The total thickness of the illustrated examples of the layered thermite coating 14 is between about 25 μm and about 1,000 μm.

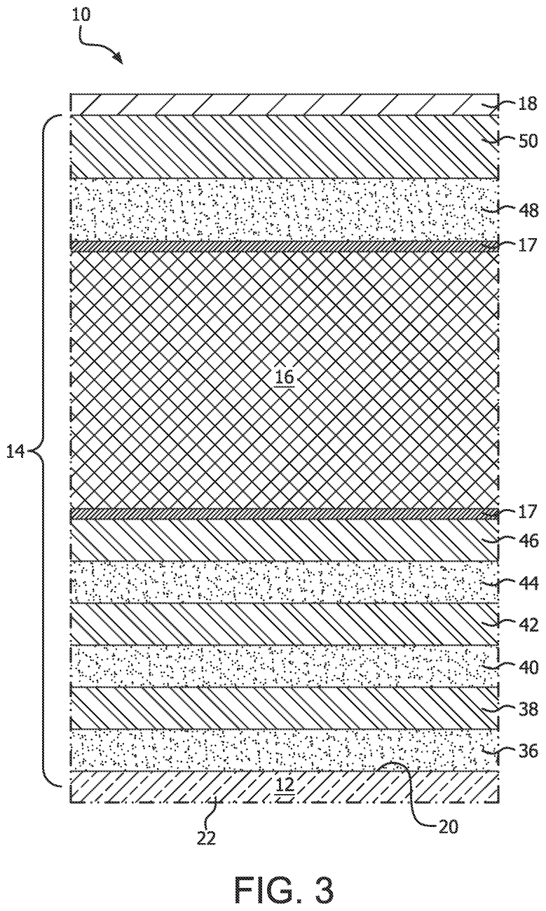

The illustrated example of the thermite coating 14 in FIGS. 1 and 2 shows a generally uniform thickness for all layers 28, 30 within the initial ignition portion 24. Similarly, a generally uniform thickness is shown within the layers 32, 34 within the secondary ignition portion 26. Other examples may include metal oxide and reducing metal layers having differing thicknesses. For example, FIG. 3 shows a primer composition 10 having thermite layers that increase generally proportionally with the distance of the layer from the substrate 12 (with only a small number of layers shown for clarity). Layers 36 and 38, which are close to the substrate 12, have a smaller thickness, for example, between about 20 nm and about 100 nm thick. Layers 40 and 42 have increased thickness. Layers 44 and 46, farther still from the substrate 12, have greater thickness than layers 40 and 42. Layers 48 and 50, adjacent to the passivation coating 18 and farthest from the substrate 12, are the thickest layers, and are thicker than about 100 nm thick. As before, the total thickness of the illustrated examples of the layered thermite coating is between about 25 μm and about 1,000 μm. Such a thermite coating would provide essentially the same advantage of rapid ignition close to the substrate 12, and relatively slower burning farther from the substrate 12 and closer to the smokeless powder, thermite propellant, or other ignitable substance. With such gradually increasing thickness, a clear boundary between an initial ignition portion and secondary ignition portion may not exist, and a definite boundary is not essential to the functioning of the invention.

As another example, all layers of metal oxide and reducing metal may be less than about 100 nm thick, and the time required to consume all layers of metal oxide and reducing metal may be increased sufficiently to ignite conventional propellants and explosives by simply increasing the number of layers of metal oxide and reducing metal.

Other examples of the layered thermite coating 14 may include layers 28, 30, 32, 34, or layers 36, 38, 40, 42, 44, 46, 48, 50, that are deposited under different temperatures, so that each layer is deposited under a temperature which is either sufficiently higher or sufficiently lower than the adjacent layers to induce thermal expansion and contraction stresses within the layered thermite coating 14 once temperature is equalized within the layered thermite coating. Such expansion and contraction stresses are anticipated to result in increased sensitivity to ignition through a physical impact.

A passivation layer 18 covers the layered thermite coating 14, protecting the metal oxide and reducing metal within the layered thermite coating 14. One example of a passivation layer 18 is silicon nitride. Alternative passivation layers 18 can be made from reactive metals that self-passivate, for example, aluminum or chromium. When oxide forms on the surface of such metals, the oxide is self-sealing, so that oxide formation stops once the exposed surface of the metal is completely covered with oxide.

The carbide-containing ceramic layer(s) 16 are disposed within the thermite layers 14. In the illustrated examples, one carbide-containing ceramic layers 16 is disposed about ⅓ of the distance to the top of the thermite coating 14. In other examples, a carbide-containing ceramic layer 16 may be located elsewhere in the thermite coating 14, such as a lower portion, a central portion, the top, the bottom, or elsewhere in the upper portion of the thermite coating 14. Some examples may include a plurality of layers carbide-containing ceramic layers 16 which are located in different positions throughout the thermite coating 14. Although one or two layers are illustrated, three or more layers may be utilized. The thickness of the carbide-containing ceramic layer(s) 16 is thicker than the metal oxide or reducing metal layers, and in the illustrated example is between about 100 nm and about 2 μm thick. Other examples of the carbide-containing ceramic layer(s) 16 may be between about 500 nm and about 1 μm thick.

Carbide-containing ceramics are selected for their propensity, when ignited by ignition of the adjacent reducing metal and metal oxide, to react with the cupric oxide to form a gas, which in the example described herein is carbon dioxide. This carbon dioxide production provides additional pressure for driving nails or other fasteners from the fastener gun. Examples include ceramics such as zirconium carbide, titanium carbide, or silicon carbide, as well as aluminum carbide (which is a metal-ceramic composite but will be considered to be a carbide-containing ceramic herein), and combinations thereof. If more than one carbide-containing ceramic layer is present, then the different carbide-containing ceramic layers may be composed of the same carbide-containing ceramic, or different carbide-containing ceramics. Ignition of these carbides (or other suitable carbides) will result in the formation of carbon dioxide through the reaction with oxygen from the cupric oxide.

When the metal oxide and reducing metal layers are ignited, the carbide-containing ceramic layers will also be ignited. In addition to the carbon-dioxide-producing reaction described above, the ignition of the carbide containing ceramics will produce relatively large (as compared to the reaction products of thermite), hot particles. These large, hot particles will burn for a sufficient period of time to ensure reliable ignition of the propellant as the reaction products are projected towards the propellant.

Some examples of the primer compound 10 may include an adhesion layer 17 above and below each carbide-containing ceramic layer 16. In the illustrated example, the adhesion layers 17 are made from titanium or chromium. Nickel may also be used as an adhesion layer in some examples. The illustrated examples of the adhesion layers 17 are about 5 nm to about 10 nm thick.

A layered thermite coating 14 can be made by sputtering or physical vapor deposition. In particular, high power impulse magnetron sputtering can rapidly produce the thermite coating 14. As another option, specific manufacturing methods described in U.S. Pat. No. 8,298,358, issued to Kevin R. Coffey et al. on Oct. 30, 2012, and U.S. Pat. No. 8,465,608, issued to Kevin R. Coffey et al. on Jun. 18, 2013, are suited to depositing the alternating metal oxide and reducing metal layers in a manner that resists the formation of oxides between the alternating layers, and the entire disclosure of both patents is expressly incorporated herein by reference. Dr. Coffey's methods permit the interface between alternating metal oxide and reducing metal layers to be either substantially free of metal oxide, or if reducing metal oxides are present, then the reducing metal oxide layer forming the interface will have a thickness of less than about 2 nm. Or a thickness of less than 1 nm. In many examples, the interface will be sufficiently thin so that most of the interface is non-measurable during high-resolution transmission electron microscope detection. Depositing individual layers of the metal oxide and reducing metal under elevated and/or reduced temperatures can optionally be used to create expansion/contraction stresses with respect to other layers within the layered thermite coating 14 as these layers return to room temperature, thereby enhancing the sensitivity of primers 10 to firing pin strikes. If desired, lithography can be used to remove undesired portions of each layer in regions of the substrates 12 where the deposited material is not desired, leaving only that portion which is intended to be coated with the primer composition 10.

A layered thermite coating 14 can also be made using a deposition system using a rotating drum. Such systems are described in the following patents or published applications, the entire disclosure of all of which are expressly incorporated herein by reference: U.S. Pat. No. 8,758,580, which was issued to R. DeVito on Jun. 24, 2014; U.S. Pat. No. 5,897,519, which was issued to J. W. Seeser et al. on Mar. 9, 1999; and EP 0,328,257, which was invented by M. A. Scobey et al. and published on Aug. 16, 1989. The use of a rotating drum system permits the substrates to be rapidly transferred between different chambers for deposition of different layers made from different materials. In one example, some chamber(s) will be used to deposit the reducing metal, other chamber(s) will be used to deposit the metal oxide, and still other chamber(s) will be used to deposit the carbide-containing ceramic. In a four chamber system, other chambers may be used to deposit the adhesion layers above and below the carbide-containing ceramic. One example may utilize between two and four chambers, with two targets per chamber. The atmospheric conditions within each chamber are maintained, and isolated from other portions of the system, by baffles which extend close to the drum while maintaining separation from the substrates. Substrates may thereby be moved between chambers by rotating the drum upon which the substrates are located while maintaining the correct pressure and atmospheric conditions of each chamber throughout the process of depositing multiple layers. Additionally, the pressure of an inert gas, for example, argon in the chamber utilized to deposit reducing metal may be greater than the pressure in the chamber utilized to deposit metal oxide, thus resisting the entry of oxygen into the reducing metal chamber. The need to pump down each chamber between layers of different material is thus avoided, speeding and simplifying the deposition process.

Prior art manufacturing methods typically required several minutes of deposition time for each of the reducing metal or metal oxide layers, with multiple minutes of additional time required to switch from depositing one material to depositing the other material. The above-described process permits each layer to be deposited in a time of, for example, about 15 seconds. Transitioning from one chamber to the next chamber can be accomplished in a time of, for example, about 2 seconds. The manufacturing process is thus significantly faster, as well as providing very little time for interface layers having undesirable characteristics to form.

The above-described procedure also minimizes the formation of reducing metal oxide during the deposition process as well as after completion of the deposition process. Without being bound by any particular theory, it is believed that interface layers formed by reactions with water vapor are more likely to grow over time through additional reaction with the reducing metal. Interfaces formed by reactions with atmospheric oxygen and/or oxygen from the deposition of metal oxide are unlikely to grow once the interface is covered by the next layer of reactant. The rapid transition from one deposition chamber to another, for example, about 2 seconds, minimizes any opportunity for water vapor to react with the surface of a deposited reducing metal layer. Again, without being bound by any particular theory, to the extent that any oxygen reacts with the reducing metal during transitions between chambers, it is believed that this oxygen is atmospheric oxygen and/or oxygen from the deposition of the metal oxide rather than oxygen from water vapor.

Once all layers of metal oxide 28, 30, reducing metal 32, 34, and carbide-containing ceramic 16 are deposited, the passivation layer 18 may be deposited onto the layered thermite coatings 14 using any of the above-described methods.

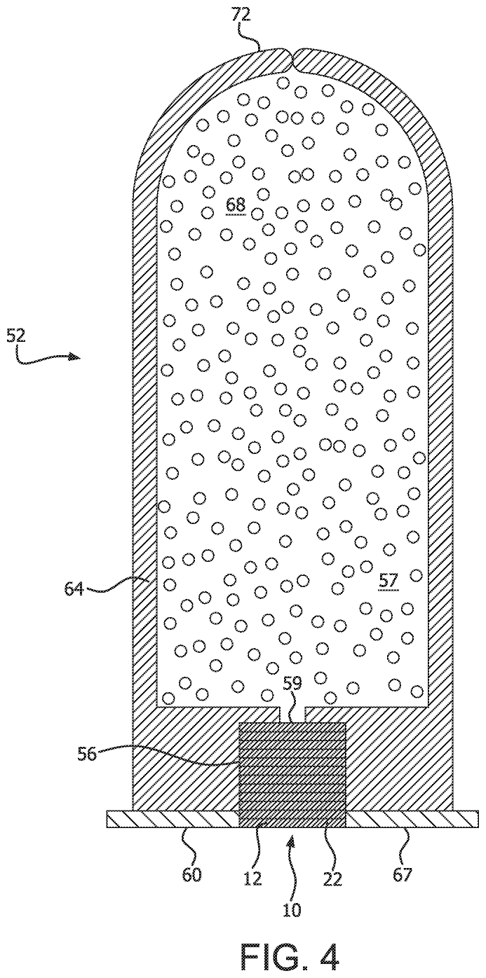

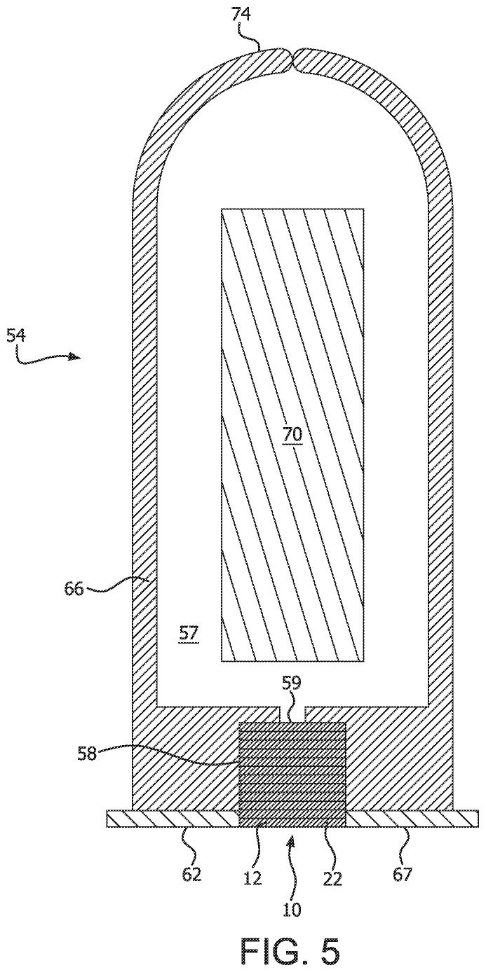

A primer 10 made as described above may be used within a fastener cartridge 52, 54, as shown in FIGS. 4-5. Prior fastening cartridges include a casing containing a single base or double base smokeless powder propellant along with a rimfire priming system. Such cartridges are presently available in .22 and .27 caliber configurations, and these or other desired calibers may be utilized for fastener cartridges using the above-described primers. As shown in FIGS. 4-5, the fastener cartridges 52, 54 utilize a centerfire structure, with the primer 10 to being secured within a primer pocket 56, 58 at the back 60, 62 of the casing 64, 66. The primer pocket is in communication with the interior 57 of the casing 64 66 through the hole 59. The back surface 22 of the substrate 12 is disposed adjacent to the back surface 67 of the casing 64, 66. Although the illustrated example of the casing 64, 66 is rimmed, a rimless casing could also be used. The illustrated examples of the cartridges 52, 54 are identical except for their propellant. Cartridge 52 utilizes a conventional single base or double base smokeless powder 68. Cartridge 54 utilizes a thermite propellant 70. Some examples of the thermite propellant may be made in the same manner as the layered thermite 14 as described above, using any of the manufacturing methods described above. Each casing 64, 66 includes a front end 72, 74 which curves inward to retain the propellant 68,70, and which can be pushed open by the reaction products of the propellant 68,70 upon ignition of the propellent 68,70.

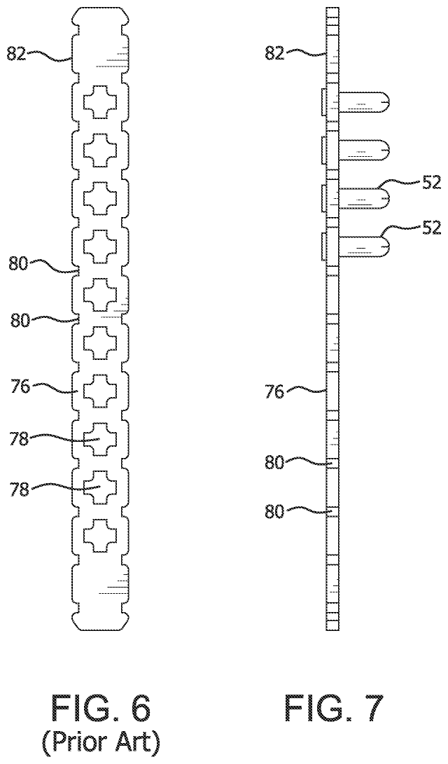

FIGS. 6-7 illustrate a prior art cartridge strip 76, which defines a plurality of openings 78 defined therein. Each opening 78 is dimensioned and configured to retain one cartridge 52,54 therein. Indexing notches 80 defined along at least one edge 82 facilitate indexing the strip 76 to sequentially align the fastener cartridges 52,54 for use within a nail gun or other fastener gun as described below.

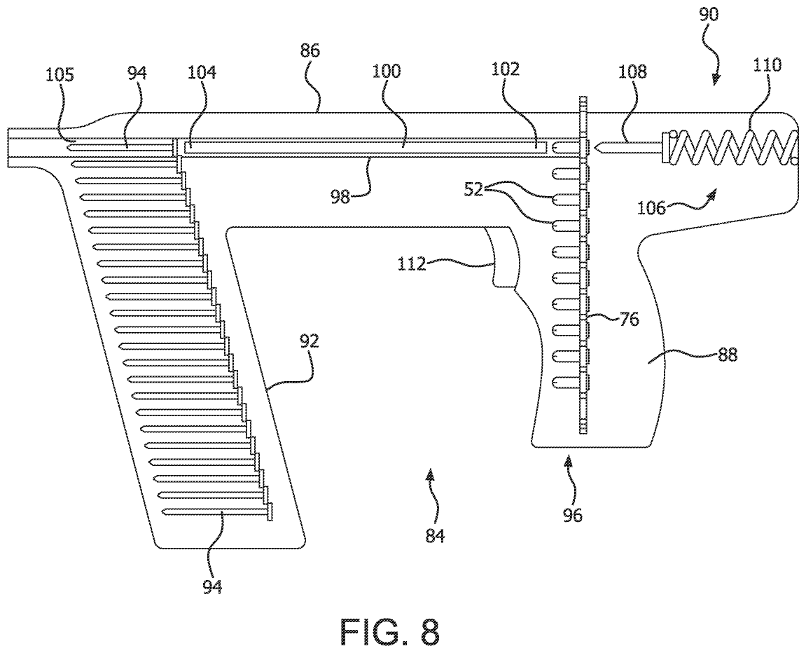

FIG. 8 illustrates an example of a fastener gun 84 utilizing mechanical ignition. The illustrated example of a fastener gun 84 is a nail gun. The fastener gun 84 includes a housing 86 defining a handgrip 88, a firing mechanism portion 90, a magazine 92 for containing fasteners 94, and a cartridge ignition location 91 disposed adjacent to the firing mechanism portion 90. In the illustrated example, the cartridge ignition location 91 is formed at the upper end of a cartridge reservoir portion 96 for receiving the cartridge strip 76 and cartridges 52,54 contained thereon. The illustrated example of a magazine 92 and fasteners 94 contained therein is conventional, and well-known to those skilled in the art.

The mechanism of the fastener gun 90 will be described only generally, since fastener gun firing mechanisms are known to those skilled in the art. The firing mechanism portion 90 houses a channel 98 containing a pusher pin 100 extending from a rearward position 102 adjacent to the fastener cartridges 52, 54 and a forward position 104 behind the fastener dispensing chamber 105 which contains the uppermost fastener 94 within the magazine 92. The firing mechanism includes a firing pin assembly 106 having a firing pin 108 and spring 110 is disposed substantially coaxially with the pusher pin. The cartridge strip 76 is held in a position which is substantially perpendicular to the channel 98, and is structured to sequentially align cartridges 52, 54 with the channel 98 and firing pin assembly 104. The firing pin 108 is normally held in a rearward position wherein the spring 110 is compressed. When the trigger 112 is pressed, the firing pin 108 is permitted to move forward under spring bias to strike the primer 10, igniting the primer. The reaction products from the primer 10 ignite the propellant 68, 70. The ignition of the propellant creates sufficient force to push the pusher pin 100 forward sufficiently quickly, and a sufficient distance to effectively drive the nail 94 completely into the wood, concrete, steel, or other structure where fastening is desired.

After driving a fastener 94, the pusher pin 100 and firing pin 108 may be returned to their original positions either automatically or manually. The strip 76 may be automatically or manually indexed to place the next cartridge 52, 54 into position for use. The next nail 94 may be automatically or manually moved into position for use. All of these steps can be performed by mechanisms which are well understood to those skilled in the art.

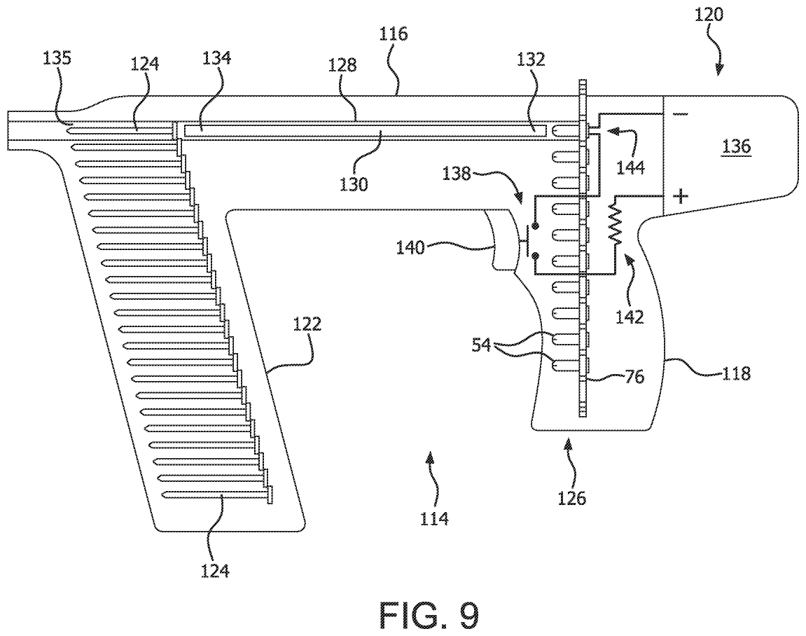

An example of a fastener gun 114 utilizing electrical ignition is illustrated in FIG. 9. The illustrated example of the fastener gun 114 is a nail gun. The fastener gun 114 includes a housing 116 defining a handgrip 118, a firing mechanism portion 120, a magazine 122 for containing fasteners 124, and a cartridge reservoir portion 126 for receiving the cartridge strip 76 and cartridges 52, 54 contained thereon. The illustrated example of a magazine 122 and fasteners 124 contained therein is conventional, and well-known to those skilled in the art.

The mechanism of the fastener gun 114 will be described only generally, since fastener gun firing mechanisms are known to those skilled in the art. The firing mechanism portion 120 houses a channel 128 containing a pusher pin 130 extending from a rearward position 132 adjacent to the fastener cartridges 52, 54 and a forward position 134 behind the fastener dispensing chamber 135 which contains the uppermost fastener 94 within the magazine 92. Power is supplied by a battery 136 which in the illustrated example is held within the ignition portion 120. The battery 136 may be any suitable primary battery, for example, lithium or alkaline, or any suitable secondary battery, for example, lithium ion, nickel metal hydride, nickel cadmium, and the like. Those skilled in the art will recognize that any of the rechargeable batteries will include a charging circuit, and that a lithium ion battery will include a protection circuit for the individual cells therein. The battery 136 is electrically connected to a normally open pushbutton switch 138 which is connected to the trigger 140, so that the pressing the trigger 140 closes the switch 138. The battery 136 is also connected through an appropriate resistor 142 to an igniter 144. The igniter 144 includes a pair of contacts which are positioned in contact with the primer of the cartridge 52, 54 which is currently aligned with the channel 128. The cartridge strip 76 is held in a position which is substantially perpendicular to the channel 128, and is structured to sequentially align cartridges 52, 54 with the channel 128 and igniter 144.

Upon depressing the trigger 140, current passes through the igniter 144 into the primer 10. Some examples of the igniter 144 may pierce the substrate 12 to improve the electrical connection between the igniter 144 and the thermite layers within the primer 10. The reaction products from the primer 10 ignite the propellant 68, 70. The ignition of the propellant creates sufficient force to push the pusher pin 130 forward sufficiently quickly, and a sufficient distance to effectively drive the nail 124 completely into the wood, concrete, steel, or other structure where fastening is desired.

After driving a fastener 124, the pusher pin 130 may be returned to its original position either automatically or manually. The strip 76 may be automatically or manually indexed to place the next cartridge 52, 54 into position for use. The next nail 124 may be automatically or manually moved into position for use. All of these steps can be performed by mechanisms which are well understood to those skilled in the art.

The present invention therefore provides a fastener gun, for example, a nail gun which is powered by fastener cartridges having thermite primers. The thermite primers can be ignited either electrically or mechanically. Unlike conventional lead azide primers, thermite primers do not release led into the atmosphere when they are ignited. The fastener gun can thus be used without a risk of inhaling lead particles. The fastener gun can be utilized without the need for an external attachment to another device, for example, an air compressor. The fastener gun can be used for a long period of time in a desired location, simplifying work in locations such as the roof of a building. Thermite primers can be deposited onto substrates and then incorporated in a cartridge casing in a manner which results in a centerfire priming system, enhancing the ignition reliability of the fastener gun.

A variety of modifications to the above-described embodiments will be apparent to those skilled in the art from this disclosure. Thus, the invention may be embodied in other specific forms without departing from the spirit or essential attributes thereof. The particular embodiments disclosed are meant to be illustrative only and not limiting as to the scope of the invention. The appended claims, rather than to the foregoing specification, should be referenced to indicate the scope of the invention.

What is claimed is:

1. A fastener gun propellant cartridge, comprising:
a casing, the casing having a front end and a back end, the back end defining a primer pocket;
a propellant within the casing;
a primer secured within the primer pocket, the primer comprising:
a substrate having a deposition surface and a rear surface;
alternating layers of metal oxide and reducing metal deposited upon the substrate, the alternating layers of metal oxide and reducing metal being structured to react with each other in response to an impact applied to the rear surface of the substrate; and
at least one carbide-containing ceramic layer within the alternating layers of metal oxide and reducing metal;
whereby, when the alternating layers of metal oxide and reducing metal react with each other, the carbide-containing ceramic layer is ignited by the reaction between the reducing metal and metal oxide, resulting in ignition of the propellant.

2. The fastener gun propellant cartridge according to claim 1, wherein the propellant further comprises:
alternating layers of metal oxide and reducing metal deposited upon the substrate; and
a carbide-containing ceramic layer within the alternating layers of metal oxide and reducing metal;
whereby, when the alternating layers of metal oxide and reducing metal react with each other, the carbide-containing ceramic layer is ignited by the reaction between the reducing metal and metal oxide, and the carbide-containing ceramic layer reacts with adjacent metal oxide and reducing metal layers to produce a gas to create pressure.

3. The fastener gun propellant cartridge according to claim 1, wherein the gas produced when the carbide-containing ceramic layer reacts with adjacent metal oxide and reducing metal layers is carbon dioxide.

4. A fastener gun powered by a centerfire fastener gun propellant cartridge, the fastener gun comprising:
a housing;
a fastener dispensing chamber within the housing;
a firing mechanism within the housing, the firing mechanism being aligned with the fastener dispensing chamber, the firing mechanism being structured to initiate a centerfire primer of a fastener gun propellant cartridge; and
a cartridge ignition location for receiving a fastener gun propellant cartridge, the cartridge ignition location being structured to position a cartridge within the cartridge channel between the firing mechanism and the fastener dispensing channel.

5. The fastener gun according to claim 4, wherein the firing mechanism includes a firing pin, the firing pin having a spring for biasing the firing pin towards the cartridge channel, the firing pin being held in a default position wherein the spring is compressed, the firing pin being released upon actuation of the fastener gun.

6. The fastener gun according to claim 4, wherein the firing mechanism includes a battery, a pair of contacts, the pair of contacts being structured to abut a primer of a fastener gun propellant cartridge which is aligned with the fastener dispensing chamber, an electrical connection between the battery and the pair of contacts, and a normally open switch, the normally open switch completing electrical connection between the battery and the contacts upon closing.

7. The fastener gun according to claim 4, wherein the cartridge ignition location is disposed at one end of a cartridge channel, the cartridge channel being structured to receive a plurality of fastener gun propellant cartridges.

8. The fastener gun according to claim 7, wherein the cartridge channel is structured to receive a cartridge retainer strip, the cartridge retainer strip holding a plurality of fastener gun propellant cartridges thereon.
